(19) United States
(12) Patent Application Publication
(10) Pub. No.: US 2004/0247829 A1
(43) Pub. Date: Dec. 9, 2004

(54) Printable sheet comprising holographic patterns and the production method of same

(76) Inventor: Gael Depres, Charavines (FR)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/482,030

(22) PCT Filed: Jun. 25, 2002
(86) PCT No.: PCT/FR02/02200

(30) Foreign Application Priority Data
Jun. 28, 2001 (FR) 01/08515

(51) Int. Cl. B32B 1/00

(52) U.S. Cl. 428/141; 428/156; 428/172

(57) ABSTRACT

The present invention relates to a printable sheet with microembossments exhibiting a holographic effect, which is characterized in that it comprises a medium coated on at least one of its faces with a pigmented coating comprising:

a non-water-soluble thermoplastic binder;

inorganic pigments chosen from:

pigments having a mean size of less than the amplitude of the microembossments, called type I pigments,

pigments having a mean size greater than the amplitude of the microembossments and having a measured BET specific surface area of greater than 10 m²/g in an amount of less than or equal to 10% with respect to the binder by dry weight, called type II pigments; and

mixtures thereof.

The subject of the present invention is also the process for producing the sheet and a printable sheet that can be thermally microembossed to form the holographic patterns and the use of the coating, allowing this sheet to be produced.

The present invention relates to a printable sheet having holographic patterns and to a process for producing it. It also relates to the printable sheet that can be thermally microembossed in order to form the holographic patterns and to the use of the coating allowing this sheet to be produced.

Holographic sheets are already known, especially paper or plastic sheets, which are obtained by applying a holographic film to a medium (the base paper or plastic sheet) or by microembossing the medium, which has been metallized, or else by thermally microembossing a thermoplastic coating extruded onto the medium. A paper with a microembossable coating has been disclosed, for example in patent U.S. Pat. No. 5,756,183. Sheets or films having holographic patterns formed in a varnish that can be crosslinked by ultraviolet radiation or by an electron beam have been disclosed, for example in Japanese patent application JP 60263140 and in German patent application DE 4 132 476.

The Applicant has found that one drawback of these sheets is that they are not printable, especially by offset printing, since the coating is too closed and the ink cannot penetrate into the sheet. In addition, it has found that if the coating includes water-soluble products, printing the sheet causes problems as the wetting solution used during printing erases the holographic effect, very certainly by dissolving the surface of the microembossed coating.

The main objectives of the invention are therefore to solve the abovementioned problems.

The Applicant has demonstrated that if a coating is produced which has pigments chosen from small inorganic pigments, that is to say having a size less than the amplitude of the embossment, and from pigments having a high specific surface area whatever their size but in small amounts, and mixtures thereof, the microembossing and the printing, especially offset printing, become possible. The term “amplitude” is understood to mean the depth of the grooves created in the coating by the embossing.

In its experience, it seems to the Applicant, without being tied to any theory, that this composition has the effect of creating microporosity in the coating which allows better drying of the ink and that, moreover in the case of small pigments, correct microembossing is obtained in order to achieve a clearly observable holographic effect and that, in the case of pigments of larger size, this does not impair the embossment since they are in a sufficiently small amount. However, the Applicant has also found that if the coating is too porous, embossing is no longer possible since the coating is no longer thermoplastic.

The invention thus provides a printable sheet with microembossments exhibiting a holographic effect, which is characterized in that it comprises a medium coated on at least one of its faces with a pigmented coating comprising:

a non-water-soluble thermoplastic binder;

inorganic pigments chosen from:

pigments having a mean size of less than the amplitude of the microembossments, called type I pigments,

pigments having a mean size greater than the amplitude of the microembossments, and having a measured BET specific surface area of greater than 10 m²/g in an amount of less than or equal to 10% with respect to the binder by dry weight, called type II pigments; and

mixtures thereof.

Of course, the type I pigments may also have a high specific surface, area.

More particularly, the invention is characterized in that said type I pigments have a mean size of less than 1 μm, preferably between 5 nm and 0.1 μm.

Preferably, the amount of said type I pigments is between 1 and 50% by dry weight with respect to the binder.

Preferably, the amount of said type II pigments is between 0.5 and 10% by dry weight with respect to the binder.

Preferably, the pigments are chosen from fumed, precipitated or colloidal silicas, titanium dioxide, precipitated or ground calcium carbonate, kaolins and mixtures thereof. Other pigments chosen from other fillers usually employed in papermaking and meeting the type I or type II criteria may be suitable. The best results have been obtained with fumed silicas in the case of type I pigments and with precipitated silicas in the case of type II pigments. The coating may additionally include other pigments, if they are in a small amount, that is to say pigments of relatively large size and of low specific surface area, it being possible for these pigments to be added in order to improve specific characteristics such as, for example, opacity or whiteness.

Preferably, the binders are chosen from thermoplastic and crosslinkable binders, crosslinking them giving them especially the property of being non-water-soluble. In particular, these said binders are binders that are non-water-soluble by nature or have been made non-water-soluble by crosslinking and are chosen from polyurethanes, styrene/butadiene copolymers, acrylic polymers, including styrene/acrylic copolymers, poly(ethylene vinyl acetate), nitrocellulose binders, photo crosslinkable starting resins, especially polymers having one or more unsaturated groups, such as acrylate methacrylate, allyl or vinyl groups, and mixtures thereof.

According to one particular case of the invention, said pigmented coating also includes thermoplastic coating pigments, especially polystyrene pigments.

According to one particular case of the invention, said pigmented coating is coated with a coating of zinc sulfide or titanium dioxide. Such a coating improves the holographic effect and the scratch resistance of the holographic patterns without changing the offset printability of the sheet. It also improves the heat resistance of the sheet and thus makes the sheet able to be printed by laser printing.

The invention also aims to provide a process for manufacturing the holographic sheet.

According to a first aspect, the invention provides a process for producing a printable sheet having holographic patterns, said patterns being produced by thermally microembossing a coating deposited on the base medium of the sheet. More specifically, this is a process for producing a printable sheet having microembossments exhibiting a holographic effect which comprises the following steps:

a pigmented coating produced in aqueous and/or organic medium, as defined above, is deposited on a base medium of the sheet, said binder being a non-water-soluble or crosslinkable thermoplastic binder;

said sheet thus coated is dried;

next, said microembossments are produced by microembossing the above coating of said sheet on a heated embossing device under pressure; and

if appropriate, the binder is crosslinked during the process.

In particular, the temperature to which the sheet is heated during the embossing operation is above the glass transition temperature T_{g} of the binder, preferably at most 100° C. above this glass transition temperature T_{g}.

According to another aspect, when the pigmented composition includes thermoplastic pigments, the invention provides a process for producing a printable sheet having holographic patterns, said patterns being produced by microembossing a coating deposited on the base medium of the sheet, said sheet having been preheated. More specifically, this is a process for producing a printable sheet having microembossments exhibiting a holographic effect, which comprises the following steps:

a pigmented coating which also includes thermoplastic pigments and is produced in aqueous and/or organic medium, as defined above, is deposited on a base medium of the sheet, said binder being a non-water-soluble or crosslinkable thermoplastic binder;

optionally, said sheet thus coated is dried;

the sheet obtained is heated;

just afterwards, said microembossments are produced by microembossing the above coating of the still hot said sheet on an unheated embossing device under pressure; and

if appropriate, the binder is crosslinked during the process.

Whichever process is used, the coating is deposited by known surface treatment and coating means, especially those commonly used in the papermaking field, such as a blade coater, air knife coat, Champion bar coater or curtain coater, by gravure printing, by a size press or by a size press with film transfer.

According to one particular case of either of the processes, in the case of a crosslinkable binder, said binder is crosslinked by ultraviolet radiation or by an electron beam or thermally. According to one particular case, the binder is crosslinked simultaneously with the embossing of the coating and more particularly said binder is crosslinked by an electron beam. Photo crosslinking the binder seems to improve the definition of the microembossments and therefore of the holographic patterns.

According to another particular case, said binder is crosslinked during the manufacture of the medium coated with said coating, in particular while said coated medium is being dried. This crosslinking makes the binder non-water-soluble. The binder may be partially crosslinked while it is being dried and may continue to crosslink just before, during or after the embossing operation.

In general, the binders are used in the form of a stabilized dispersion in aqueous medium (called lattices) or in nonaqueous solvent medium or in mixed (aqueous/organic solvent) medium; the photo crosslinkable binders (crosslinked by UV radiation or by an electron beam) are generally used without solvent in the form of mixtures of monomers or oligomers.

Preferably, the binders have a glass transition temperature T_{q} which is tailored to the temperature at which the embossing will be carried out, that is to say those whose glass transition temperature T_{g} is below the temperature at which the embossing operation is carried out. However, it is preferable to choose binders whose T_{g} is as hiqh as possible since the Applicant has found that binders with a high T_{g} give the holographic patterns a better scratch resistance.

Conventional embossing processes for forming holographic patterns are carried out hot and under a pressure of at least 5×10⁶ Pa (50 bar)—the embossing temperature is generally between 50 and 200° C. The choice of temperature/pressure pair is important in order to obtain the desired high-quality holographic effects—a person skilled in the art will know how to determine these data by simple test trials and by reference to the examples mentioned below.

Any type of medium may be suitable, bearing in mind that the medium has an importance as regards the penetration of the binder and the final use of the product. The more open the medium, the greater will have to be the amount of coating deposited in order to “cover” the medium. The coating must have a thickness of greater than or equal to the amplitude of the embossments, that is to say in general greater than 0.5 μm. There is no imperative upper limit, however both the cost and the use of the sheet must be taken into account.

The media may be chosen from uncoated papers, coated papers, natural tracing paper obtained by thorough refining of the cellulose fibers, the paper being possibly colored, transparentized papers impregnated with a transparentizing product, colored papers, security papers, particularly those with watermarks, or grained papers, in particular impregnated papers for book binding or covering. Security papers are used for making security documents or banknotes, and thick grained papers are used especially to make passport covers. These media may also be plastic sheets or films, especially sheets or films made of polyolefins, especially polyethylene or polypropylene. The media may have received a treatment for promoting the retention of the coating, these treatments being known elsewhere (precoating, adhesion primer, corona treatment).

The invention also relates to a printable sheet having holographic patterns, obtained by the processes as defined above.

The holographic sheets obtained according to the invention may have many applications. They may be employed in the field of printable creative media for making offset printable media with a holographic background (geometrical patterns, images, etc.) or with holographic inscriptions in the manner of a watermark, again for the purpose of creating 3D effects. They may also be employed in the security documents field for low-cost protection (logos, train tickets, etc.), since the holographic pattern cannot be photocopied and cannot be easily produced (at the very least, a microembossing press is needed to counterfeit the product). They may be used for making covers or for booking binding, such as passport covers.

The invention also relates to a coated printable sheet that can be thermally microembossed to form holographic patterns, said sheet including a coating as defined above.

The invention also relates to the use of a coating as defined above for coating a sheet and making it printable and able to be thermally microembossed to form holographic patterns.

The invention will be more clearly understood with the aid of the following nonlimiting examples:

### EXAMPLE 1

A paper according to the invention was produced in the laboratory.

Deposited on a 120 g/m² paper medium, of the POP'SET® brand from Arjo Wiggins Dessin et Papiers Fins, using a pilot coater, was the following coating composition:

| | |
|---|---|
| Water: | 600 g |
| Binder: | poly(ethylene/vinyl acetate) |
| solids content | 50%; T_{g} = 60° C., |
| sold under the name VINAMUL 3525 | 200 g |
| by Vinamul: | (commercial weight) |
| Pigments: | fumed silica; |
| solids content: | 98%; |
| pigment size: | 12 nm; |
| BET specific surface area: | 200 m²/g; |
| sold under the name AEROSIL 200 | 200 g |
| by Degussa-Huls: | (commercial weight) |

This composition had a solids content of 15% and a Brookfield viscosity of 150 mPa·s measured at 100 rpm. The amount deposited was 7 g/m² by dry weight. The amount of fumed silica was 22% with respect to the binder (by dry/dry weight).

The sheet was dried at about 100° C. and the binder was crosslinked during this drying.

In the laboratory, holographic patterns were produced on the sheet obtained by embossing the coated face on a press having a shim with negative microembossments of the patterns, at a pressure of 17.10⁶ Pa (170 bar), the platen in contact with the shim being at a temperature of 140° C. A sheet having microembossments forming holographic patterns was obtained.

Printing tests were then carried out on the microembossed face of the papers, by means of a 4-color offset press using an OPTIMA® ink from Lorilleux. These tests showed that the paper was printable and with no set-off. This test was carried out using a piston to apply a pressure of 250 N to a surface 2.3 cm in diameter on two sheets printed with a 400% charge of ink. The drying time of the ink was from 3 hours depending on the test, which was satisfactory for this type of paper.

### EXAMPLE 2

A paper according to the invention was produced in the laboratory.

Deposited on a 170 g/m² paper medium, of the MAINE® brand of Arjo Wiggins Papiers Couches, using a pilot coater, was the following coating composition:

| | |
|---|---|
| Water: | 400 g |
| Binder: | poly(styrene/acrylic): |
| solids content: | 50%; Tg = 27C; |
| sold under the name | 200 g |
| ACRONAL S305D by BASF: | (commercial weight) |
| Pigments: | precipitated silica; |
| solids content: | 98%; |
| BET specific surface area: | 400 m²/g; |
| sive of the pigments: | 7 μm; |
| sold under the name SYLOID 74C | 3 g |
| by Grace Davison: | (commercial weight) |

This composition had a solids content of 17% and a Brookfield viscosity of 60 mPa·s measured at 100 rpm.

The amount deposited was 3 g/m² by dry weight.

The fraction of silica was 3% with respect to the binder (by dry/dry weight).

The sheet was dried at about 100° C. and the binder was crosslinked during this drying.

Holographic patterns were produced in the laboratory on the sheet obtained by embossing the coated face on a press with a shim having negative microembossments of the patterns, under a pressure of 17×10⁶ Pa (170 bar), the platen of the press in contact with the shim being at a temperature of 80° C.

A sheet having microembossments forming holographic patterns was obtained.

Printing tests were then carried out on the microembossed face of the papers, using the apparatus called Prüfbau Print Test. The set-off test was carried out with the OPTIMA® ink from Lorilleux. This test showed that the paper was printable and that the set-off was satisfactory.

### EXAMPLE 3

To determine the influence of the T_{g} of the binder on the scratch resistance of the hologram, we produced a sheet to be compared with example 1.

This sheet was coated with the composition according to example 1, but in which the VINAMUL 3525 binder (T_{g}=60° C.) was replaced with a binder of the same chemical nature having a different relative proportion of monomers—the binder VINAMUL 3479, which had a T_{g} of 30° C.

The two sheets obtained according to this example 3 and according to example 1 respectively, once they had been embossed using the process of example 1, exhibited similar holographic effects. However, the scratch resistance of the coated sheet according to this example 3 (with the binder having the lower glass transition temperature) was lower than that of the other sheet according to example 1.

The resistance was estimated by a finger nail scratch test.

### EXAMPLE 4

A paper according to the invention was produced in the laboratory.

Deposited on a 120 g/m² paper medium, of the POP'SET® brand from Arjo Wiggins Dessin et Papiers Fins, using a pilot coater, was the following coating composition:

| | |
|---|---|
| Binder: | photo crosslinkable |
| | triacrylate resin |
| sold under the name | 100 g |
| SARTOMER SR 351 by Cray Valley: | |
| Pigments: | precipitated silica; |
| solids content: | 98%; |
| BET specific surface area: | 400 g/m²; |
| size of the pigments: | 7 μm; |
| sold under the name SYLOID 74C | 3 g |
| by Grace Davison: | (commercial weight) |

The amount deposited was 10 g/m² by dry weight. The silica fraction was 3% with respect to the binder (by dry/dry weight).

The coating was crosslinked by an electron beam while being embossed by the shim carrying negative microembossments of the patterns.

A sheet having microembossments forming holographic patterns was obtained.

Printing tests were then carried out on the microembossed face of the papers, using an apparatus called Prüfbau Print Test. The set-off test was carried out with the OPTIMA® ink from Lorilleux. This test showed that the paper was printable and that the set-off was satisfactory.

### EXAMPLE 5 (COMPARATIVE EXAMPLE)

A paper was produced in the laboratory in the following manner.

Deposited on a 120 g/m² paper medium, of the POP'SET® brand from Arjo Wiggins Dessin et Papiers Fins, using a pilot coater, was the following coating composition:

| | |
|---|---|
| Water: | 250 g |
| Binder: | poly(ethylene/vinyl acetate); |
| solids content: | 50%; T_{g} = 60° C.; |
| solder under the name | 200 g |
| VINAMUL 3525 by Vinamul: | (commercial weight) |
| Pigments: | ground calcium carbonate; |
| solids content: | 97%; |
| BET specific surface area: | 7-10 m²g; |
| size of the pigments: | 1 to 2 μm; |
| sold under the name | 500 g |
| HYDROCARB 90 by the company Omya | (commercial weight) |

This composition had a solids content of 60% and a Brookfield viscosity of 200 mPa·s measured at 100 rpm. The amount deposited was 4 g/m² by dry weight.

A fraction of carbonate was 500% with respect to the binder (by dry/dry weight).

The sheet was dried at about 100° C. and the binder was crosslinked during this drying.

It was impossible to obtain a holographic effect in the laboratory, whatever the embossing pressure and temperature.

The coating used corresponded to the usual coating compositions in the printing-writing field. The high content of large-sized (1-2 μm) pigments compared with the amplitude (0.5 μm) of the embossments prevented the coating from being embossed. This example therefore shows that a standard coating for text printing is not suitable.

### EXAMPLE 6

A paper according to the invention was produced in the laboratory.

Deposited on an 80 g/m² paper medium, of the OPALE® brand from Arjo Wiggins Dessin et Papiers Fins, using a pilot coater, was the following coating composition:

| | |
|---|---|
| Water: | 493 g |
| Binder: | polyurethane and |
| | polyacrylic varnishes: |
| solids content: | 45%; |
| Tg of the blend about 110° C.: | 133 g |
| | (commercial weight) |
| Inorganic pigments: | fumed silica; |
| solids content | 98%; |
| size of the pigments: | 12 nm; |
| BET specific surface area: | 200 m²/g; |
| sold under the name AEROSIL 200 | 40 g |
| by the company Degussa-Huls: | (commercial weight) |
| Thermoplastic pigments: | hollow polystyrene; |
| solids content: | 26.5%; T_{g} = 100° C.; |
| sold under the name | 300 g |
| ROPAQUE HP 1055 by Rohm & Haas: | (commercial weight) |

The amount deposited was 7 g/m² by dry weight. The sheet was dried at about 105° C. and the binder was crosslinked during this drying.

Holographic patterns were produced in the laboratory on the sheet obtained by embossing the coated face, the sheet being preheated at 80° C. for 10 seconds and then just afterwards, the sheet remaining hot, the microembossments were produced on a press having a shim with negative microembossments of the patterns, under a pressure of 21×10⁶ Pa (210 bar) for 10 seconds, the shim not being heated.

A sheet having microembossments forming holographic patterns was obtained.

Printing tests carried out on the microembossed face of the papers using a 4-color offset press with an OPTIMA® ink from Lorilleux showed that the paper was printable and with no setting off.

1. A printable sheet with microembossments exhibiting a holographic effect, comprising a medium coated on at least one of its faces with a pigmented coating comprising:
a non-water-soluble thermoplastic binder;
inorganic pigments chosen from:
pigments having a mean size of less than the amplitude of the microembossments, called type I pigments,
pigments having a mean size greater than the amplitude of the microembossments and having a measured BET specific surface area of greater than 10 m²/g in an amount of less than or equal to 10% with respect to the binder by dry weight, called type II pigments; and
mixtures thereof.

2. A sheet as claimed in claim 1, wherein said type I pigments have a mean size of less than 1 μm, preferably between 5 nm and 0.1 μm.

3. A sheet as claimed in claim 1, wherein the amount of said type I pigments is between 1 and 50% by dry weight with respect to the binder.

4. A sheet as claimed in claim 1, wherein the amount of said type II pigments is between 0.5 and 10% by dry weight with respect to the binder.

5. A sheet as claimed in claim 1, wherein the pigments are chosen from fumed, precipitated or colloidal silicas, titanium dioxide, precipitated or ground calcium carbonate, kaolins and mixtures thereof.

6. A sheet as claimed in claim 5, wherein said non-water-soluble thermoplastic binders are binders that are non-water-soluble by nature or have been made non-water-soluble by crosslinking and are chosen from polyurethanes, styrene/butadiene copolymers, acrylic polymers, including styrene/acrylic copolymers, poly(ethylene vinyl acetate), nitrocellulose binders, photo crosslinkable starting resins, especially polymers having one or more unsaturated groups, such as acrylate methacrylate, allyl or vinyl groups, and mixtures thereof.

7. A sheet as claimed in claim 1, wherein said pigmented coating also includes thermoplastic coating pigments, especially polystyrene pigments.

8. A sheet as claimed in claim 1, wherein said pigmented coating is coated with a coating of zinc sulfide or titanium dioxide.

9. A process for producing a printable sheet having microembossments exhibiting a holographic effect, according to claim 1, comprising the following steps:
a pigmented coating produced in aqueous and/or organic medium, is deposited on a base medium of the sheet, said binder being a non-water-soluble or crosslinkable thermoplastic binder;
said sheet thus coated is dried;
next, said microembossments are produced by microembossing the above coating of said sheet on a heated embossing device under pressure; and
if appropriate, the binder is crosslinked during the process.

10. A process for producing a printable sheet having microembossments exhibiting a holographic effect, according to claim 1, comprising the following steps:
a pigmented coating which is produced in aqueous and/or organic medium is deposited on a base medium of the sheet, said binder being a non-water-soluble or crosslinkable thermoplastic binder;
optionally, said sheet thus coated is dried;
the sheet obtained is heated;
just afterwards, said microembossments are produced by microembossing the above coating of the still hot said sheet on an unheated embossing device under pressure; and
if appropriate, the binder is crosslinked during the process.

11. A process as claimed in claim 9, wherein the temperature to which the sheet is heated during the embossing operation is greater than the glass transition temperature T_{g} of the binder, preferably at most 100° C. above this glass transition temperature T_{g}.

12. A process as claimed in claim 9 and in the case of a crosslinkable binder, wherein said binder is crosslinked by ultraviolet radiation or by an electron beam or thermally.

13. A process as claimed in claim 12, wherein said binder is crosslinked during manufacture of the medium coated with said coating, in particular while said coated medium is being dried.

14. A process as claimed in claim 12, wherein the binder is crosslinked by an electron beam at the same time as the coating is being embossed.

15. A process as claimed in claim 9, wherein said coating has a thickness of greater than or equal to the amplitude of the embossments.

16. A process as claimed in claim 9, wherein a zinc sulfide or titanium dioxide coating is vacuum-deposited on the pigmented coating.

17. A printable sheet having microembossments exhibiting a holographic effect, obtained according to the process defined as claimed in claim 9.

18. A coated printable sheet that can be thermally microembossed to form patterns having a holographic effect, said sheet including a coating as defined in claim 1.

19. Use of a coating as defined in claim 1 for coating a sheet and making it printable and able to be thermally microembossed to form patterns having a holographic effect.
